(19) United States
(12) Patent Application Publication
(10) Pub. No.: US 2011/0135184 A1
(43) Pub. Date: Jun. 9, 2011

(54) X-RAY IMAGE COMBINING APPARATUS AND X-RAY IMAGE COMBINING METHOD

(75) Inventor: Naoto Takahashi, Kunitachi-shi (JP)

(73) Assignee: CANON KABUSHIKI KAISHA, Tokyo (JP)

(21) Appl. No.: 12/958,231

(22) Filed: Dec. 1, 2010

(30) Foreign Application Priority Data
Dec. 3, 2009 (JP) 2009-275916

(51) Int. Cl. G06K 9/00

(52) U.S. Cl. 382/132

(57) ABSTRACT

An X-ray image combining apparatus includes a evaluation value calculation unit configured to calculate an evaluation value of each pixel from a neighboring area containing at least two pixels corresponding to a same position, a weight coefficient determination unit configured to determine a weight coefficient of the corresponding two pixels based on the evaluation value, and a combination unit configured to multiply the two pixels by the determined weight coefficient and add the multiplied values.

### BACKGROUND OF THE INVENTION

1. Field of the Invention

The present invention relates to an X-ray image combining apparatus that combines two X-ray images captured for a long size picture and an X-ray image combining method.

2. Description of the Related Art

In recent years, in medical X-ray imaging apparatuses, digital X-ray imaging apparatuses in various systems have been widely used as the digital technologies advance. For example, a system to directly digitize an X-ray image using an X-ray detector having a fluorescent material and a large-area amorphous silicon (a-Si) sensor closely attached with each other without using an optical system and the like has been put in practical use.

Similarly, a system to directly photoelectrically convert X-ray radiation using an amorphous selenium (a-Se) and the like to convert the radiation into electrons, and detect the electrons using a large-area amorphous silicon sensor has also been put in practical use.

In the imaging using the X-ray imaging apparatuses, there is long size imaging. In the long size imaging, a long part of a subject such as a whole spine or a whole lower limb of a human body is to be a target of the imaging. Generally, the above-mentioned X-ray detector has a limit in its imaging range. Accordingly, it is difficult to perform such imaging with a single image, i.e., at one shoot.

To solve the above-described shortcoming of conventional X-ray imaging apparatuses, Japanese Patent Application Laid-Open No. 2006-141904 discuses a long size imaging method in which a part of an imaging area is captured in a plurality of times in such a manner that the captured imaging areas are partly overlapped, and the partly captured X-ray images are combined.

As the method to combine partial images captured in a plurality of shooting, for example, Japanese Patent Application Laid-Open No. 62-140174 discusses a method. In the method, weighted addition is performed on pixels of two partial images corresponding to an overlapped area based on a distance from a non-overlapped area. With this method, it is said that the partial images can be seamlessly combined.

In the long size imaging, in order to reduce unnecessary X-ray irradiation or effect of scattered rays to a subject, irradiation field restriction for restricting an X-ray irradiation range to an X-ray detector can be performed.

In this case, as illustrated in FIG. 5, an overlapped area may include an unirradiated field area where the target is not irradiated with X-ray radiation. Accordingly, if the weighted addition is directly performed on the pixels of the two partial images corresponding to the overlapped area, an artifact due to the unirradiated field area may occur. Thus, in order to suitably perform the combination of the partial images, it is necessary to consider the X-ray unirradiated field area in each partial image.

As the method to consider the X-ray unirradiated field area, for example, a user can manually set an irradiation field area to each partial image, and combine only clipped irradiation field areas of the partial images. However, in the method, there is a problem that the user has to set the irradiation field areas to the plurality of partial images. Accordingly, the operation is cumbersome.

The irradiation field areas can be automatically recognized from the partial images, and the clipped irradiation field areas of the partial images can be combined. However, the recognition of the irradiation field areas may not always be correctly performed. Then, areas narrower or wider than the original irradiation field areas may be incorrectly recognized.

If the areas narrower than the original irradiation field areas are recognized, overlapped areas necessary for the combination may be also cut out, and correct combination may not be performed. Further, if the areas wider than the original irradiation field areas are recognized, an artifact due to the unirradiated field areas may occur.

The irradiation field area can be calculated based on positional information of an X-ray detector and an X-ray tube or opening information of an X-ray collimator. However, depending on the alignment accuracy, an error with respect to the original irradiation field area may occur. Accordingly, the method has a problem similar to the case of automatically recognizing the irradiation field area.

### SUMMARY OF THE INVENTION

The present invention is directed to an X-ray image combining apparatus and an X-ray image combining method performing combination with reduced occurrence of an artifact due to an unirradiated field area even if an overlapped area contains the unirradiated field area.

According to an aspect of the present invention, An X-ray image combining apparatus that combines two X-ray images having an overlapped area includes an evaluation value calculation unit configured to acquire corresponding pixels from the overlapped area in the two X-ray images, and calculate an evaluation value of each pixel based on the values of the pixels in a predetermined range in the acquired pixels, a weight coefficient determination unit configured to determine a weight coefficient of corresponding two pixels of the overlapped area based on the evaluation values calculated in the evaluation value calculation unit, and a combining unit configured to multiply the two pixels by the weight coefficient determined by the weight coefficient determination unit and add the multiplied values to form a combined pixel.

Further features and aspects of the present invention will become apparent to persons having ordinary skill in the art from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall configuration of an X-ray imaging apparatus according to a first exemplary embodiment.

FIG. 2 is a flowchart illustrating an operation relating to an X-ray image combining unit according to the first exemplary embodiment.

FIG. 3 illustrates an overall configuration of an X-ray imaging apparatus according to a second exemplary embodiment.

FIG. 4 is a flowchart illustrating an operation relating to an X-ray image combining unit according to the second exemplary embodiment.

FIG. 5 illustrates an issue in the known technique.

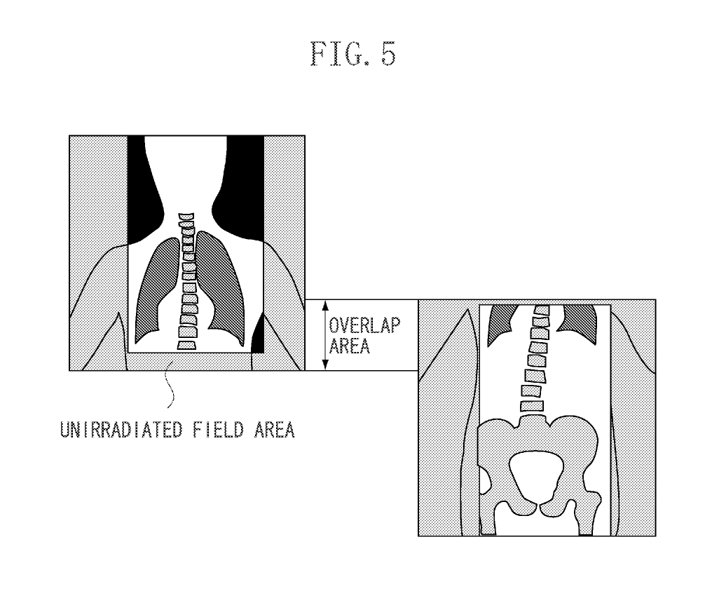

FIG. 6 illustrates a control method in long size imaging.

FIG. 7 illustrates a method of calculating positional information.

FIG. 8 illustrates a method of calculating a weight coefficient.

### DESCRIPTION OF THE EMBODIMENTS

Various exemplary embodiments, features, and aspects of the invention will be described in detail below with reference to the drawings.

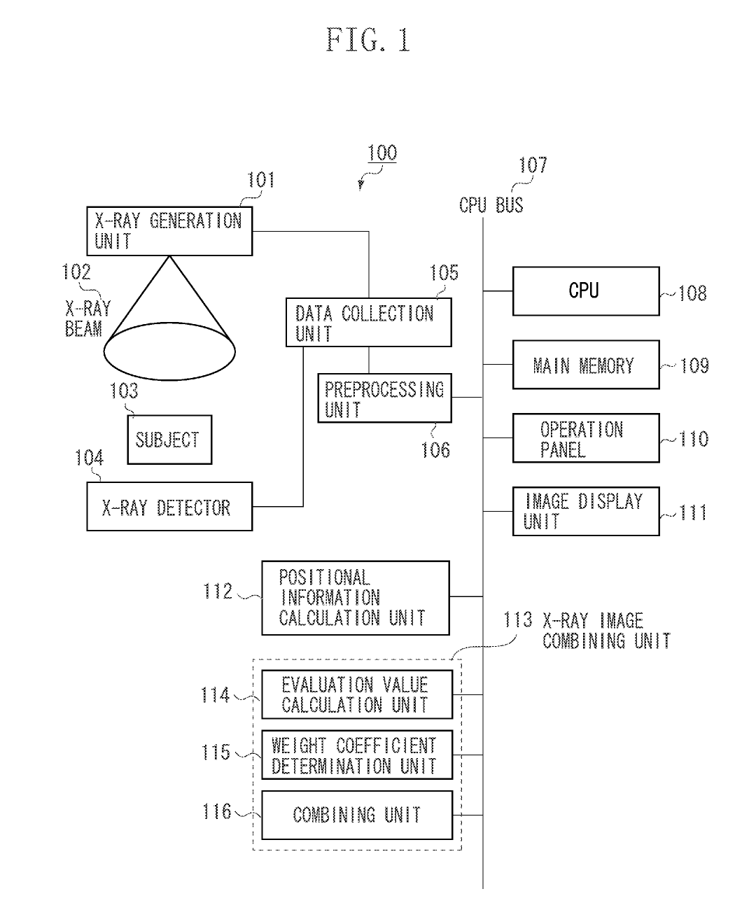

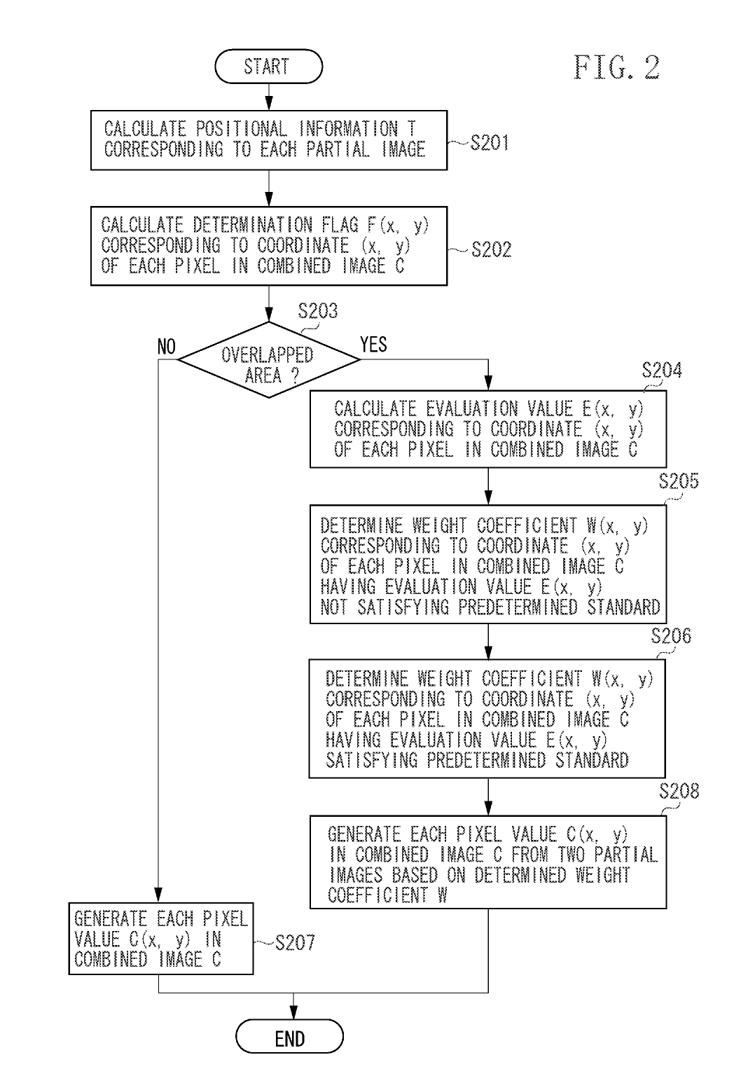

FIG. 1 illustrates an overall configuration of an X-ray imaging apparatus having functions of the first exemplary embodiment of the present invention. FIG. 2 is a flowchart illustrating a characteristic operation relating to an X-ray image combining unit. First, the first exemplary embodiment is described with reference to FIGS. 1 and 2.

The exemplary embodiment of the present invention is, for example, applied to an X-ray imaging apparatus 100 illustrated in FIG. 1. As illustrated in FIG. 1, the X-ray imaging apparatus 100 has functions of combining captured partial images and performing effective processing to subsequently output (print or display) the combined image in appropriate media (e.g., on a film or a monitor).

The X-ray imaging apparatus 100 includes a data collection unit 105, a preprocessing unit 106, a central processing unit (CPU) 108, a main memory 109, an operation panel 110, an image display unit 111, a positional information calculation unit 112, and an X-ray image combining unit 113. These components are connected with each other via a CPU bus 107, which is capable of sending and receiving data to the components connected thereto.

In the X-ray imaging apparatus 100, the data collection unit 105 and the preprocessing unit 106 are connected with each other, or—in some instances—the two units may form a single unit. An X-ray detector 104 and an X-ray generation unit 101 are connected to the data collection unit 105. The X-ray image combining unit 113 includes an evaluation value calculation unit 114, a weight coefficient determination unit 115, and a combining unit 116. Each unit is connected to the CPU bus 107.

In the X-ray imaging apparatus 100, the main memory 109 stores various data necessary for processing in the CPU 108, and serves as a working memory of the CPU 108. The CPU 108 performs operation control of the entire the X-ray imaging apparatus 100 in response to an operation from the operation panel 110 using the main memory 109. With the configuration, the X-ray imaging apparatus 100 operates as described below.

First, if a shooting instruction is input by a user via the operation panel 110, the shooting instruction is transmitted to the data collection unit 105 by the CPU 108. The CPU 108, in response to the shooting instruction, controls the X-ray generation unit 101 and the X-ray detector 104, so that an X-ray imaging operation is implemented.

In the X-ray imaging operation, first, the X-ray generation unit 101 emits an X-ray beam 102 towards a subject 103. The X-ray beam 102 emitted from the X-ray generation unit 101 transmits through the subject 103 while attenuating, and arrives at the X-ray detector 104. Then, the X-ray detector 104 detects the X-ray radiation incident thereupon and outputs X-ray image data. In the present exemplary embodiment, it is assumed that the subject 103 is a human body. More specifically, the X-ray image data output from the X-ray detector 104 corresponds to a condition of the subject 103, and in this embodiment the X-ray image data is assumed to be an image of a human body or a part thereof.

The data collection unit 105 converts the X-ray image signal output from the X-ray detector 104 into a predetermined digital signal, and supplies the signal to the preprocessing unit 106 as X-ray image data. The preprocessing unit 106 performs preprocessing such as offset correction processing and gain correction processing to the signal (X-ray image data) from the data collection unit 105.

The X-ray image data pre-processed in the preprocessing unit 106 is temporarily stored in the main memory 109 as original image data by the control of the CPU 108 via the CPU bus 107.

In the long size imaging, the shooting is performed a plurality of times while the X-ray generation unit 101 and the X-ray detector 104 are being controlled. Then, N partial images which have an overlapped area are acquired as original image data.

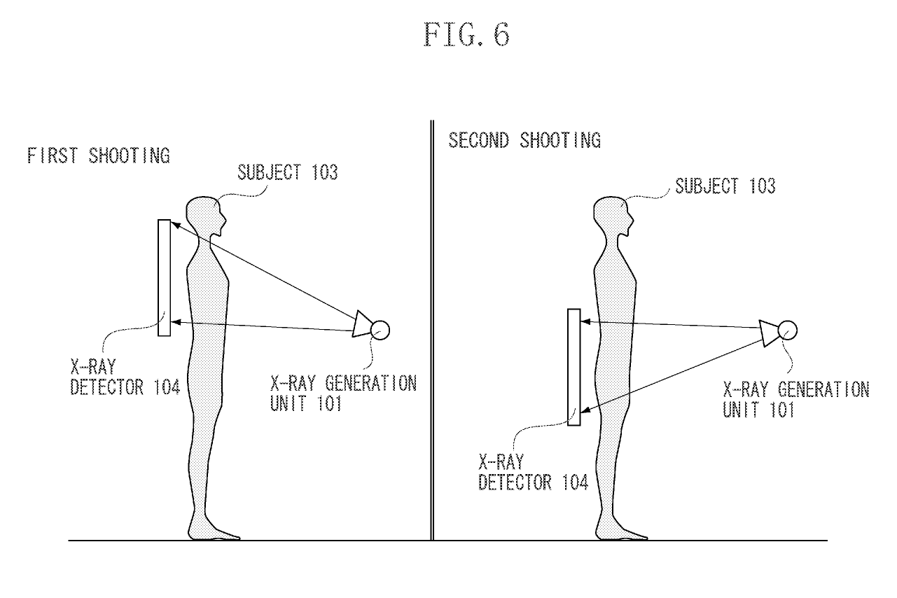

The control method is not limited to the above-described method. For example, as illustrated in FIG. 6, a moving mechanism (not illustrated) that can move the X-ray detector 104 in the long side direction of the subject 103 can be provided. Thus, while the X-ray detector 104 is moved to the subject 103, the emission direction of the X-ray beam to be generated from the X-ray generation unit 101 can be changed. Thus, the plurality of shooting can be performed.

The positional information calculation unit 112 calculates positional information of each partial image captured by the long size imaging. The positional information is supplied to the X-ray image combining unit 113 by the control of the CPU 108 via the CPU bus 107.

The X-ray image combining unit 113 combines N sheets of partial images captured in the long size imaging. The X-ray image combining unit 113 includes an evaluation value calculation unit 114, the weight coefficient determination unit 115, and a combining unit 116. The evaluation value calculation unit 114 calculates an evaluation value of each image based on a neighboring region containing at least two pixels corresponding to the same position. The weight coefficient determination unit 115 determines a weight coefficient to the two corresponding pixels based on the evaluation value calculated in the evaluation value calculation unit 114. The combining unit 116 multiplies the two pixels by the weight coefficient determined by the weight coefficient determination unit 115 and adds them and combines the images. Each component is connected to the CPU bus 107.

Hereinafter, characteristic operation relating to the X-ray image combining unit 113 in the X-ray imaging apparatus 100 having the above-described configuration is specifically described with reference to the flowchart in FIG. 2.

In step S201, the N partial images obtained by the preprocessing unit 106 are supplied to the positional information calculation unit 112 provided at a previous stage of the X-ray image combining unit 113 via the CPU bus 107. The positional information calculation unit 112 calculates positional information corresponding to each partial image Pᵢ (i=1, 2, . . . N).

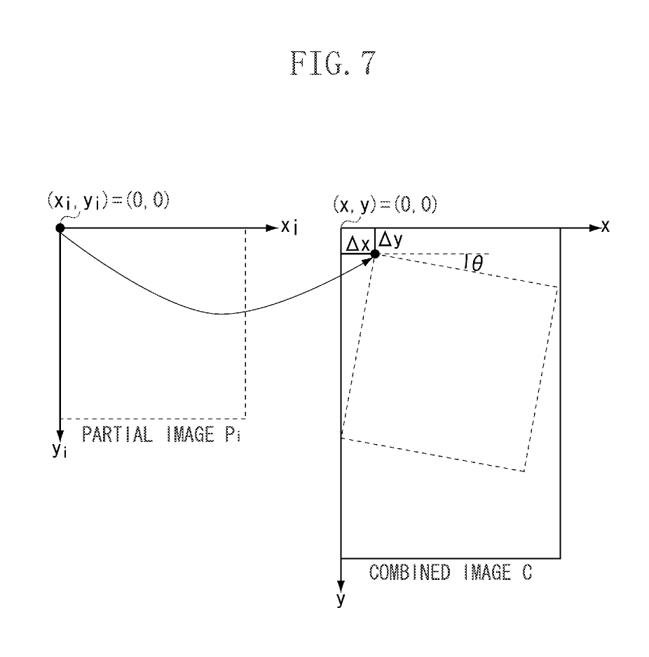

As illustrated in FIG. 7, the positional information is used to map the partial image Pᵢ to a combined image C by rotation and translation. The positional information is calculated as the affine transformation matrix Tᵢ illustrated below.

$${T}_{i} = [ \begin{matrix}cos θ & - sin θ & Δ x \\ sin θ & cos θ & Δ y \\ 0 & 0 & 1\end{matrix} ] \qquad ( 1 )$$

where, θ is a rotational angle (rad), Δx is an amount of translation (pixel) in an x direction, and Δy is an amount of translation (pixel) in a y direction.

The calculation method of the positional information is not limited to the above. For example, by acquiring positional information from an encoder unit (not illustrated) attached to the X-ray detector 104, an affine transformation matrix of each partial image can be calculated.

Each partial image can be displayed on the image display unit 111, and the user can manually set a rotational angle and a translation amount via the operation panel 110. Based on the information set by the user, an affine transformation matrix can be calculated.

Further, as discussed in Japanese Patent Application Laid-Open No. 2006-141904, the subject 103 can wear a marker. The marker is detected from a captured partial image, and an affine transformation matrix can be automatically calculated based on the marker of successive partial images.

In the X-ray image combining unit 113, the evaluation value calculation unit 114 executes each step in steps S202 to S204. By the operation, a determination flag F for determining whether the partial image Pᵢ corresponding to each pixel in the combined image C exists or not, and an evaluation value E are calculated.

In step S202, first, a coordinate (xᵢ, yᵢ) of the partial image Pᵢ corresponding to a coordinate (x, y) of each pixel of the combined image C is calculated according to the following equation:

$$[ \begin{matrix}{x}_{i} \\ {y}_{i} \\ 1\end{matrix} ] = {T}_{i}^{- 1} [ \begin{matrix}x \\ y \\ 1\end{matrix} ] \qquad ( 2 )$$

Then, whether the calculated coordinate (xᵢ, yᵢ) is a coordinate within the partial image is determined. For example, if the number of rows of the partial image is defined as Rows, and the number of the lines of the partial image is defined as Columns, the calculated coordinate (xᵢ, yᵢ), when 0≦xᵢ<Columns, and 0≦yᵢ<Rows are satisfied, is determined as a coordinate within the partial image. If the equations are not satisfied, it is determined that the coordinate is outside the partial image.

The determination result is stored in a determination flag F (x, y) as N-bit data. More specifically, if the coordinate (xᵢ, yᵢ) is within the partial image, a value of i-th bit of the F (x, y) is defined as 1. If the coordinate (xᵢ, yᵢ) is outside the partial image, the value of i-th bit of the F (x, y) is defined as 0. Then, the determination results of the N pieces of the partial images are stored.

In step S203, based on the determination flag F (x, y), whether the coordinate (x, y) of each pixel in the combined image C is in an overlapped area of the two partial images is determined. More specifically, in N bits of the determination flag F (x, y), if two of the bits are 1, it is determines that the area is the overlapped area.

In normal long size imaging, three or more partial images are not overlapped on an overlapped area. Accordingly, three or more bits of 1 do not exist. If one bit is 1, it is a non-overlapped area where only one partial image exists. If all bits are 0, it is a blank space where no partial image exists.

In step S203, if it is determined that the area is the overlapped area (YES in step S203), in step S204, an evaluation value E (x, y) corresponding to the coordinate (x, y) of each pixel in the combined image C is calculated. The evaluation value E (x, y) is used to determine either pixel is in an unirradiated field area.

More specifically, in the two partial images corresponding to the coordinate (x, y) of each pixel in the combined image C, if the pixel value of the partial image corresponding to higher-order bits of the determination flag F (x, y) is defined as Pᵤ (xᵤ, yᵤ), and a pixel value of the partial image corresponding to lower-order bits is defined as P_{d} (x_{d}, y_{d}), then, as illustrated in the following equation, an absolute value of a difference between the pixel values is calculated as an evaluation value E (x, y).

E(x,y)=|Pᵤ(xᵤ,yᵤ)−P_{d}(x_{d},y_{d})|

In the above equation, if the coordinate (xᵤ, yᵤ) of the partial image Pᵤ or the coordinate (x_{d}, y_{d}) of the partial image P_{d} is not an integer value, the pixel value of the coordinate can be calculated by interpolation. The interpolation method is not limited to a specific method. For example, a known technique such as a nearest neighbor interpolation, a bilinear interpolation, and a bicubic interpolation can be used.

In the present exemplary embodiment, the difference between one pixel and one pixel (corresponding pixels) is used for the evaluation value. However, the evaluation value is not limited to this example. For example, an average value can be obtained in neighbor areas around a coordinate of each partial image, and a difference between the average values can be used as an evaluation value. A pixel value difference, a variance difference, a variance ratio, a correlation value, and the like in a predetermined range around a coordinate of each partial image may be used as an evaluation value.

Next, in the X-ray image combining unit 113, the weight coefficient determination unit 115 executes each step in steps S205 and S206, and a weight coefficient W in the overlapped area is determined.

In step S205, in the coordinate (x, y) of each pixel in the combined image C that is determined as the overlapped area, a weight coefficient W (x, y) for a pixel having an evaluation value E (x, y) that does not satisfy a predetermined reference is determined. The pixel that does not satisfy the predetermined reference means that in the two partial images corresponding to the coordinate (x, y), one of the two pixels is in an unirradiated field area.

In the present exemplary embodiment, an absolute value error of the corresponding two pixels is used as the evaluation value E. Accordingly, if one of the two pixels is in the unirradiated field area, the evaluation value E increases. Accordingly, when the evaluation value E is larger than a threshold TH, it can be determined that the pixel does not satisfy the predetermined reference. The threshold TH may be a value determined empirically by experiment, it can be statistically established. For example, the threshold may be based on an average value of pixels surrounding the coordinate (x, y), or it can be statistically obtained from a plurality of sample images.

As described above, if it is determined that the pixel has the evaluation value E (x, y) that does not satisfy the predetermined reference, in the two corresponding pixels, a pixel that has a small X-ray dosage level (that is, a pixel corresponding to the unirradiated field area) is to have the weight coefficient of 0.0, and the other pixel is to have the weight coefficient of 1.0. Normally, X-ray images have large pixel values in proportion to the dosage (or the logarithm of the dosage). Accordingly, by comparing the pixel values of the two pixels to each other, the one having the small pixel value may have the weight coefficient of 0.0, and the other pixel may have the weight coefficient of 1.0. Alternatively, a pixel in a first partial image perceived to be in the non irradiated area and having a small dosage level (e.g., by leakage) may have a weight coefficient of 0.1, while a corresponding pixel in a second partial image within an irradiated area and having high dosage may have a weight coefficient of 0.9. In this case, the sum of the weight coefficients is also 1. However, if each of the two corresponding pixels has a low weight coefficient the sum will not be 1; in which case the corresponding pixels are not part of the overlapped area.

The sum of the two weight coefficients is always 1. Accordingly, it is not necessary to store the weight coefficients in the memory. Thus, in the weight coefficient W (x, y), only the weight coefficient corresponding to the pixel of the partial image corresponding to the higher-order bits of the determination flag F (x, y) is recorded.

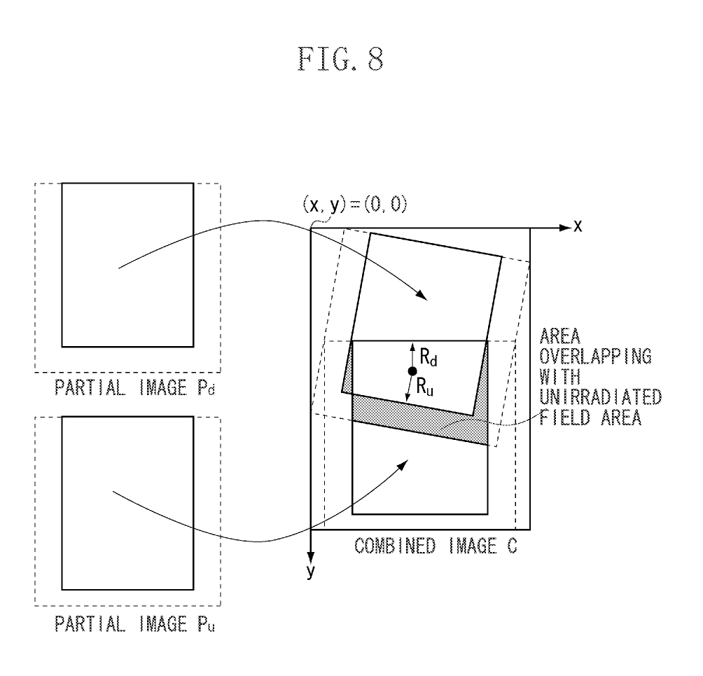

In step S206, in the coordinates (x, y) of each pixel that is determined as the overlapped area in the combined image C, a weight coefficient W (x, y) to a pixel that has the evaluation value E (x, y) satisfying the predetermined reference (that is, in the pixels of the two partial images, both pixels are in the irradiated field area or in the unirradiated field area) is determined. More specifically, as illustrated in FIG. 8, in the coordinates (x, y) of each pixel in the combined image C, in the area the non-overlapped area of the partial image P_{d} overlaps with the unirradiated field area of the partial image Pᵤ, a distance R_{d} to a nearest pixel is calculated.

Further, in the area where the non-overlapped area of the partial image Pᵤ that overlaps with the unirradiated field area of the partial image P_{d}, a distance Rᵤ to a nearest pixel is calculated. Then, a weight coefficient Wᵤ to the pixel in the partial image Pᵤ and a weight coefficient W_{d} to the pixel in the partial image P_{d} are determined using a following equation.

Wᵤ=P_{d}/(Rᵤ+R_{d})

W_{d}=1−Wᵤ

The sum of the two weight coefficients is always 1. Accordingly, it is not necessary to store both weight coefficients in the memory. Thus, in the weight coefficient W (x, y), only the weight coefficient corresponding to the pixel of the partial image corresponding to the higher-order bits of the determination flag F (x, y) is recorded.

Next, in the X-ray image combining unit 113, the combining unit 116 executes each step in steps S207 and S208, and the combined image C is generated.

In step S207, first, a pixel value C (x, y) of each pixel that is determined as the pixel not in the overlapped area (No in step S203) in the combined image C is calculated. The pixels of the area determined as the pixels not in the overlapped area are classified into two types, that is, a non-overlapped area where only one partial image exists and a blank area where no partial image exists.

Accordingly, in a case of the non-overlapped area where only one partial image exists, the pixel value Pᵢ (xᵢ, yᵢ) of the partial image Pᵢ corresponding to the pixel value C (x, y) is directly used. In a case of the blank area, a fixed value is used. For the fixed value, for example, a maximum value or a minimum value of the image can be used.

In step S208, the pixel value C (x, y) of each pixel that is determined as the overlapped area in the combined image C is calculated. More specifically, in the two partial images corresponding to the coordinate (x, y) of each pixel in the combined image C, if the pixel value of the partial image corresponding to the higher-order bits of the determination flag F (x, y) is defined as Pᵤ (xᵤ, yᵤ), and the pixel value of the partial image P_{d} corresponding to the lower-order bits is defined as P_{d} (x_{d}, y_{d}), then, the pixel value C (x, y) of the combined image is calculated by the following equation.

C(x,y)=W(x,y)×Pᵤ(xᵤ,yᵤ)+(1−W(x,y))×P_{d}(x_{d},y_{d})

Accordingly, the pixel value C (x, y) of each pixel in the overlapped area of the combined image C is formed by multiplying each of the corresponding pixels of the two partial images by its respective weight coefficient and adding the multiplied values.

As described above, according to the first exemplary embodiment, if one of the partial images is in the unirradiated field area, the weight coefficient of the pixel corresponding to the unirradiated field area is determined to be 0.0. By the operation, the combination can be performed with reduced artifact due to the unirradiated field area.

Further, as to the other overlapped areas, by the weighted addition corresponding to distances, the change of the pixel values can be gradually performed from one partial image to the other partial images. Accordingly, seamless combination can be performed.

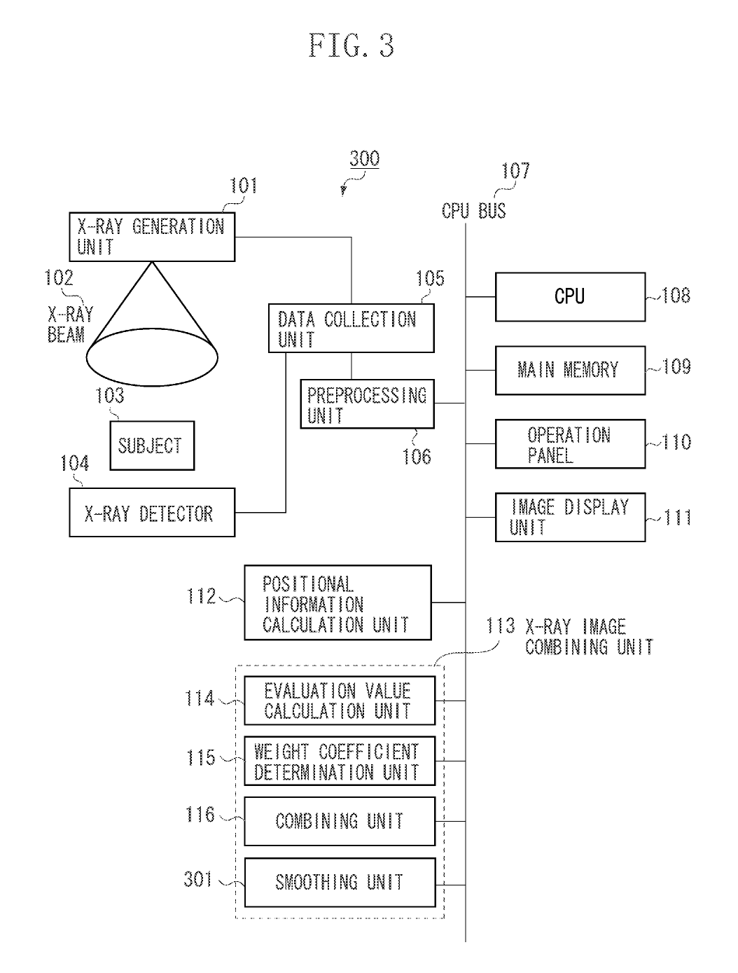

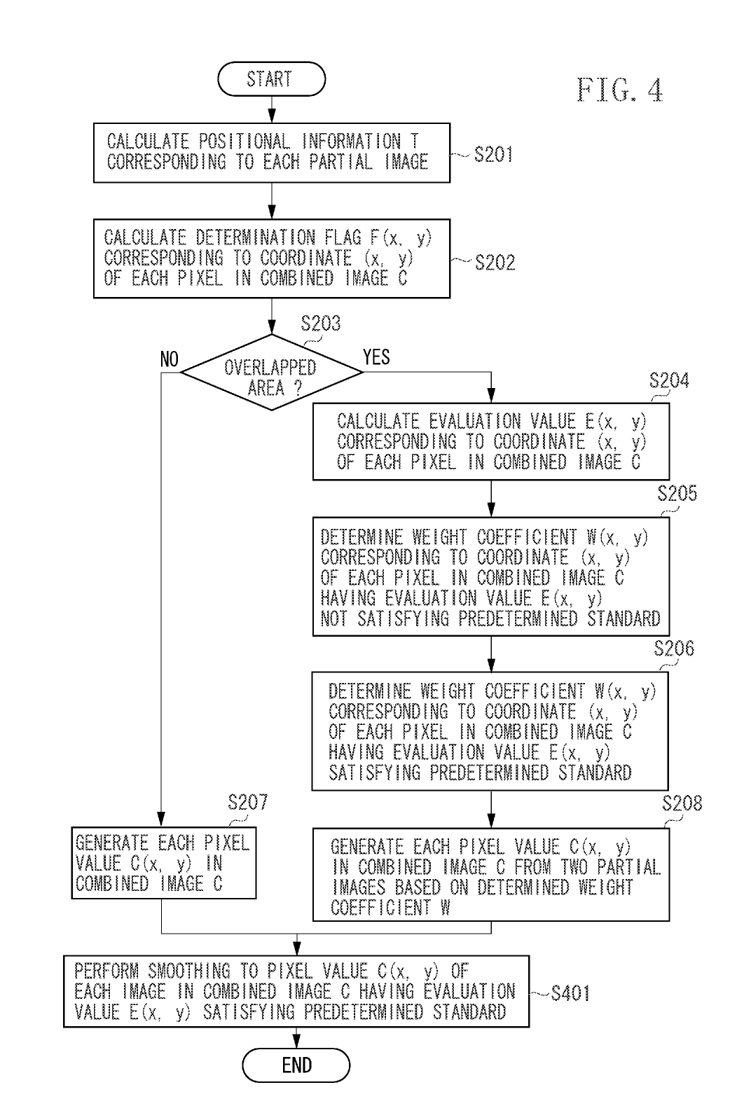

FIG. 3 illustrates an overall configuration of an X-ray imaging apparatus having functions according to a second exemplary embodiment of the present invention. FIG. 4 is a flowchart illustrating a characteristic operation relating to an X-ray image combining unit.

The present exemplary embodiment of the present invention is, for example, applied to an X-ray imaging apparatus 300 illustrated in FIG. 3. Different from the X-ray imaging apparatus 100, the X-ray imaging apparatus 300 has a smoothing unit 301.

In the X-ray imaging apparatus 300 illustrated in FIG. 3, with respect to parts that operate similarly to those in the X-ray imaging apparatus 100 in FIG. 1, the same reference numerals as those in FIG. 1 are denoted, and detailed descriptions thereof are omitted. In the flowchart in FIG. 4, with reference to steps that perform operations similarly to that in the flowchart illustrated in FIG. 2, the same reference numerals as those in FIG. 2 are denoted, and only configurations different from those in the above-described first exemplary embodiment are specifically described.

First, as described above, by executing each step in steps S201 to S208, the combined image C is generated.

In step S401, in the X-ray image combining unit 113, the smoothing unit 301 performs smoothing operation on the combined image C. More specifically, in the coordinates (x, y) of each pixel that is determined as the overlapped area in the combined image C, the smoothing operation using a low-pass filter is performed only to a pixel (that is, a pixel combined by the weighted addition corresponding to the distance) that has the evaluation value E (x, y) that satisfies a predetermined reference. The low-pass filter can be, for example, a rectangular filter or a Gaussian filter.

As described above, in the second exemplary embodiment, to the pixels to which the weighted addition corresponding to the distances is performed, the smoothing operation is further performed. By the operation, if the area of the overlapped area is small and it is difficult to gradually change the pixel values from one partial image to the other partial images, the partial images can be seamlessly combined.

While the present invention has been described with reference to the preferred exemplary embodiments, it is to be understood that the invention is not limited to the above-described exemplary embodiments, various modifications and changes can be made without departing from the scope of the invention.

The aspects of the present invention can also be achieved by directly or remotely providing the system or the device with a storage medium which records a program (in the exemplary embodiments, a program corresponding to the flowcharts illustrated in the drawings) of software implementing the functions of the exemplary embodiments and by reading and executing the provided program code with a computer of the system or the device.

Accordingly, the program code itself that is installed on the computer to implement the functional processing according to the exemplary embodiments constitutes the present invention. That is, the present invention includes the computer program itself that implements the functional processing according to the exemplary embodiments of the present invention.

As the recording medium for supplying the program, for example, a hard disk, an optical disk, a magneto-optical disk (MO), a compact disk read-only memory (CD-ROM), a compact disk recordable (CD-R), a compact disk rewritable (CD-RW), a magnetic tape, a nonvolatile memory card, a ROM, and a digital versatile disk (DVD) (DVD-ROM, DVD-R) may be employed.

The program can be supplied by connecting to a home page in the Internet using a browser in a client computer. Then, the computer program can be supplied from the home page by downloading the computer program itself according to the exemplary embodiments of the present invention or a compressed file including an automatic installation function into a recording medium such as a hard disk.

Further, the program code constituting the program according to the exemplary embodiments of the present invention can be divided into a plurality of files, and each file may be downloaded from different home pages. That is, a WWW server that allows downloading of the program file to a plurality of users for realizing the functional processing according to the exemplary embodiments of the present invention in the computer is also included in the present invention.

Further, the program according to the exemplary embodiments of the present invention may be encrypted and stored on a storage medium such as a CD-ROM, and distributed to users. A user who has cleared prescribed conditions is allowed to download key information for decrypting from a home page through the Internet. Using the key information, the user can execute the encrypted program, and the program is installed onto the computer.

In addition, the functions according to the exemplary embodiments described above can be implemented by executing the read program code by the computer, or an operating system (OS) or the like working on the computer can carry out a part of or the whole of the actual processing on the basis of the instruction given by the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-275916 filed Dec. 3, 2009, which is hereby incorporated by reference herein in its entirety.

What is claimed is:

1. An X-ray image combining apparatus that combines two X-ray images having an overlapped area, the X-ray imaging apparatus comprising:
an evaluation value calculation unit configured to acquire corresponding pixels from the overlapped area in the two X-ray images, and calculate an evaluation value of each pixel based on the values of the pixels in a predetermined range in the acquired pixels;
a weight coefficient determination unit configured to determine a weight coefficient of corresponding two pixels of the overlapped area based on the evaluation values calculated in the evaluation value calculation unit; and
a combining unit configured to multiply the two pixels by the weight coefficient determined by the weight coefficient determination unit and add the multiplied values to form a combined pixel.

2. The X-ray image combining apparatus according to claim 1, wherein the evaluation value calculation unit calculates at least one of a pixel value difference, a variance difference, a variance ratio, and a correlation value of a predetermined range containing at least two pixels corresponding to a same position.

3. The X-ray image combining apparatus according to claim 1, wherein the weight coefficient determination unit determines, in the two pixels, a weight coefficient to a pixel having a smaller X-ray dosage level as 0 if the evaluation value in at least two pixels corresponding to the same position does not satisfy a predetermined reference.

4. The X-ray image combining apparatus according to claim 1, wherein the weight coefficient determination unit determines each weight coefficient based on a distance from the two pixels to a pixel in a nearest non-overlapped area or a pixel having the evaluation value not satisfying the predetermined reference if the evaluation values in the two pixels corresponding to the same position satisfies the predetermined reference.

5. The X-ray image combining apparatus according to claim 1, further comprising a smoothing unit configured to perform smoothing operation using a low-pass filter to each pixel after combination based on the evaluation value of each pixel calculated by the evaluation value calculation unit.

6. The X-ray image combining apparatus according to claim 5, wherein the smoothing unit performs the smoothing to the combined pixels if the evaluation values in the two pixels corresponding to the same position satisfy the predetermined reference.

7. An X-ray image combining method combining two X-ray images having an overlapped area, the X-ray imaging method comprising:
calculating an evaluation value of each pixel from a neighboring area containing at least two pixels corresponding to a same position;
determining a weight coefficient of the corresponding two pixels based on the calculated evaluation value; and
combining by multiplying the two pixels by the weight coefficient determined in the weight coefficient determination and adding the multiplied values.

8. A computer readable medium containing stored thereon a computer-executable program for performing the X-ray image combining method according to claim 7.
